(19) United States
(12) Patent Application Publication
(10) Pub. No.: US 2026/0063663 A1
(43) Pub. Date: Mar. 5, 2026

(54) ACCELEROMETER

(71) Applicant: AAC Kaitai Technologies (Wuhan) CO., LTD, Wuhan (CN)

(72) Inventors: Shitao Yan, Shenzhen (CN); Shan Yang, Shenzhen (CN); Zhan Zhan, Shenzhen (CN); Zhao Ma, Shenzhen (CN); Xiao Kan, Shenzhen (CN); Hongtao Peng, Shenzhen (CN); Yang Li, Shenzhen (CN); Kahkeen Lai, Singapore (SG); Qiuyu Tan, Singapore (SG)

(21) Appl. No.: 19/385,008

(22) Filed: Nov. 10, 2025

Related U.S. Application Data
(63) Continuation-in-part of application No. 18/088,823, filed on Dec. 27, 2022.
Application No. 18/088,823 is a continuation of application No. PCT/CN2022/122711, filed on Sep. 29, 2022.

(30) Foreign Application Priority Data
Aug. 31, 2022 (CN) 202211055760.3

(51) Int. Cl. G01P 15/125; G01P 15/08; G01P 15/18

(52) U.S. Cl. CPC G01P 15/125; G01P 15/18; G01P 2015/0831

(57) ABSTRACT

The present invention provides an accelerometer, including base, anchor points, seesaw structures elastically, and a differential detection assembly; the seesaw structures includes a first seesaw structure and a second seesaw structure which are parallel to each other and placed in reverse; the anchor points includes first anchor points and second anchor points; the first seesaw structure includes first elastic members and a first mass block connected to the first elastic members; the first mass block is driven by a normal phase carrier drive signal from the first anchor points; the second seesaw structure includes second elastic members and a second mass block connected to the second elastic members; and the second mass block is driven by a reversed phase carrier drive signal from the second anchor points. The accelerometer can effectively suppress the impact of noise of an angular acceleration of rotation.

### CROSS-REFERENCE TO RELATED APPLICATIONS

The application is a continuation in part of U.S. application Ser. No. 18/088,823, filed on Dec. 27, 2022, which is a continuation of International Application No. PCT/CN2022/122711 filed on Sep. 29, 2022, the contents of which are incorporated herein by reference in their entireties.

### TECHNICAL FIELD

The present invention relates to the technical field of micro electro mechanical systems, in particular to an accelerometer.

### BACKGROUND

For multi-axis accelerometers in the related technology, Z-axis out-of-plane acceleration detection and Y-axis in-plane acceleration detection share an asymmetric rotational test mass. X-axis in-plane acceleration detection takes an entire seesaw structure as a linear test mass. Three-axis detection is achieved through corresponding capacitance plates.

However, acceleration detection modalities of the Y axis and the Z axis are the same as motion modalities under the action of external angular acceleration around the Z axis and the Y axis, and the center of mass of a structure is not at the same point as the center of mass of the test mass, so that the accelerometer has a low ability to resist the impact of the external angular acceleration around the Z axis and the Y axis during the detection of the Y axis and the Z axis. At the same time, when a base tilts and deforms around the Y axis due to thermal stress and the like, a differential detection capacitor for Z-axis detection will be directly affected by the tilting of the base, resulting in a bias error in an output due to the tilting of the base.

### SUMMARY

The present invention aims to provide an accelerometer to suppress the impact of an angular acceleration of rotation in the relevant technology on detection.

An embodiment of the present invention provides an accelerometer, including base, anchor points arranged on the base, and seesaw structures elastically connected to the anchor points, wherein the accelerometer further comprises a differential detection assembly used for detecting accelerations of the seesaw structures; the seesaw structures comprise a first seesaw structure and a second seesaw structure, wherein the first seesaw structure and second seesaw structure are nested; the anchor points comprise first anchor points elastically connected to the first seesaw structure, and second anchor points elastically connected to the second seesaw structure; the first seesaw structure comprises first elastic members connected to the first anchor points, and a first mass block connected to the first elastic members; the first mass block is driven by a normal phase carrier drive signal from the first anchor points; the second seesaw structure comprises second elastic members connected to the second anchor points, and a second mass block connected to the second elastic members; and the second mass block is driven by a reversed phase carrier drive signal from the second anchor points; the first mass block comprises a first mass portion connected to the first elastic members, and two second mass portions extending from the first mass portion in a X-axis direction toward the second mass block; the two second mass portions are spaced apart in a Y-axis direction; the X-axis direction is perpendicular to the Y-axis direction; the second mass block comprises a third mass portion connected to the second elastic members, and a fourth mass portion extending from the third mass portion in the X-axis direction toward the first mass block; the side of the first mass portion facing the second mass block in the X-axis direction is recessed away from the second mass block along the X-axis direction to form a first recess; the fourth mass portion is received in the first recess; the two second mass portions are arranged on opposite sides of the third mass portion in the Y-axis direction; under the action of an acceleration in a Z-axis direction, the first seesaw structure rotates and tilts anticlockwise around the Y-axis direction, and the second seesaw structure rotates and tilts clockwise around the Y-axis direction; under the action of an acceleration in the Y-axis direction, the first seesaw structure rotates and tilts clockwise around the Z axis direction, and the second seesaw structure rotates and tilts anticlockwise around the Z axis direction; under an acceleration in the X-axis direction, the first seesaw structure and the second seesaw structure both translate along the X axis direction; the Z-axis direction is perpendicular to the X-axis direction and the Y-axis direction.

Further, the two sides of the third mass portion in the Y-axis direction are recessed towards each other along the Y-axis direction to form two second recesses, and the two second mass portions are correspondingly accommodated in the two second recesses; the first anchor points are disposed between the first mass portion and the third mass portion and are connected to the first mass portion via the first elastic members; the second anchor points are disposed between the first mass portion and the third mass portion and are connected to the third mass portion via the second elastic members.

Further, the first seesaw structure and the second seesaw structure are nested to form a rectangular structure.

Further, the first anchor points include two and are spaced apart along the Y-axis direction on both sides of the fourth mass portion; the first elastic members include two, and each of the first anchor points is connected to the first mass portion via one first elastic member; the second anchor points include two and are spaced apart along the Y-axis direction on both sides of the fourth mass portion; the second elastic members include two, and each of the second anchor points is connected to the third mass portion via one second elastic member.

Further, the moment of inertia of the first mass portion around the first elastic members matches the moment of inertia of the fourth mass portion around the second elastic members; and the moment of inertia of the two second mass portions around the first elastic members matches the moment of inertia of the third mass portion around the second elastic members.

Further, the differential detection assembly includes a first Z-axis capacitance detection electrode disposed on the base, and the orthographic projection of the first Z-axis capacitance detection electrode along the Z-axis direction covers a portion of the first mass portion and a portion of the fourth mass portion; a first Z-axis differential detection capacitor is formed by the spacing between the portion of the first Z-axis capacitance detection electrode facing the first mass portion in the Z-axis direction and the first mass portion; a second Z-axis differential detection capacitor is formed by the spacing between the portion of the first Z-axis capacitance detection electrode facing the fourth mass portion in the Z-axis direction and the fourth mass portion; and plate spacings of the first Z-axis differential detection capacitor and the second Z-axis differential detection capacitor are the same.

Further, wherein the differential detection assembly further comprises two second Z-axis capacitance detection electrodes disposed on the base, the orthographic projection of each second Z-axis capacitance detection electrode along the Z-axis direction covers a portion of the second mass portion and a portion of the third mass portion; a third Z-axis differential detection capacitor is formed by the spacing between the portion of the second Z-axis capacitance detection electrode facing the second mass portion in the Z-axis direction and the second mass portion; a fourth Z-axis differential detection capacitor is formed by the spacing between the portion of the second Z-axis capacitance detection electrode facing the third mass portion in the Z-axis direction and the third mass portion; plate spacing of the third Z-axis differential detection capacitor and the fourth Z-axis differential detection capacitor are the same, and plate spacing of the third Z-axis differential detection capacitor is the same as that of the first Z-axis differential detection capacitor, so as to form two sets of differential Z-axis detection capacitors.

Further, wherein the first mass block includes a plurality of first through holes extending along the Z-axis direction through the first mass block, the plurality of first through holes being arranged along the Y-axis and spaced apart from each other, each first through hole being rectangular with a long side parallel to the X-axis direction; the second mass block includes a plurality of second through holes extending along the Z-axis direction through the second mass block, the plurality of second through holes being arranged along the Y-axis and spaced apart from each other, each second through hole being rectangular with a long side parallel to the X-axis direction; each first through hole has a first side wall parallel to the X-axis direction; each second through hole has a second side wall parallel to the X-axis direction; the differential detection assembly includes a plurality of first Y-axis capacitance detection electrodes disposed on the base and located within the plurality of first through holes and the plurality of second through holes, the plurality of first Y-axis capacitance detection electrodes being correspondingly arranged with the plurality of first through holes and the plurality of second through holes; a first Y-axis differential detection capacitor is formed between each Y-axis capacitive detection electrode and each first side wall facing the first Y-axis capacitance detection electrode, and a second Y-axis differential detection capacitor is formed between each first Y-axis capacitance detection electrode and each second side wall facing the first Y-axis capacitance detection electrode; plate spacings of the first Y-axis differential detection capacitor and the second Y-axis differential detection capacitor are the same.

Further, the first through holes each further include a third side wall opposite to the first side wall along the Y-axis direction, and the second through holes each further include a fourth side wall opposite to the second side wall along the Y-axis direction, and the differential detection assembly further includes a plurality of second Y-axis capacitance detection electrodes disposed on the base and located within the plurality of first through holes and the plurality of second through holes, a third Y-axis differential detection capacitor is formed between each second Y-axis capacitance detection electrode and each third side wall facing the second Y-axis capacitance detection electrode, and a fourth Y-axis differential detection capacitor is formed between each second Y-axis capacitance detection electrode and each fourth side wall facing the second Y-axis capacitance detection electrode; plate spacings of the third Y-axis differential detection capacitor and the fourth Y-axis differential detection capacitor are the same; and plate spacings of the third Y-axis differential detection capacitor and the first Y-axis differential detection capacitor are the same; so as to form two sets of Y-axis detection capacitors.

Further, the first mass block further includes a plurality of third through holes extending along the Z-axis direction through the first mass block, the plurality of third through holes being arranged along the X-axis and spaced apart from each other, each third through hole being rectangular with a long side parallel to the Y-axis direction, the second mass block further includes a plurality of fourth through holes extending along the Z-axis direction through the second mass block, the plurality of fourth through holes being arranged along the Y-axis and spaced apart from each other, each fourth through hole being rectangular with a long side parallel to the Y-axis direction, each third through hole further includes a fifth side wall parallel to the Y-axis direction, each fourth through hole further includes a sixth side wall parallel to the Y-axis direction, and the differential detection assembly further includes a plurality of first X-axis capacitance detection electrodes disposed on the base and located within the plurality of third through holes and the plurality of fourth through holes, a first X-axis differential detection capacitor is formed between each first X-axis capacitance detection electrode and each fifth side wall facing the first X-axis capacitance detection electrode, and a second X-axis differential detection capacitor is formed between each first X-axis capacitance detection electrode and each sixth side wall facing the first X-axis capacitance detection electrode; plate spacings of the first X-axis differential detection capacitor and the second X-axis differential detection capacitor are the same.

Further, the third through holes each further include a seventh side wall opposite to the fifth side wall along the X-axis direction, and the fourth through holes each further include an eighth side wall opposite to the sixth side wall along the X-axis direction, and the differential detection assembly further includes a plurality of second X-axis capacitance detection electrodes disposed on the base and located within the plurality of third through holes and the plurality of fourth through holes, a third X-axis differential detection capacitor is formed between each second X-axis capacitance detection electrode and each seventh side wall facing the second X-axis capacitance detection electrode, and a fourth X-axis differential detection capacitor is formed between each second X-axis capacitance detection electrode and each eighth side wall facing the second X-axis capacitance detection electrode; plate spacings of the third X-axis differential detection capacitor and the fourth X-axis differential detection capacitor are the same; plate spacings of the third X-axis differential detection capacitor and the first X-axis differential detection capacitor are the same; so as to form two sets of X-axis detection capacitors.

Further, the plurality of third through holes includes at least two columns arranged at intervals along the Y-axis direction; the plurality of fourth through holes includes at least two columns arranged at intervals along the X-axis direction.

Further, the accelerometer further comprising an upper cover arranged on one side of the seesaw structure facing away from the base.

The beneficial effects of the present invention lie in: the normal phase carrier drive signal and the reversed phase carrier drive signal with opposite phases are respectively applied to the first anchor point and the second anchor point of the parallel and reversed first seesaw structure and second seesaw structure, potentials of the first seesaw structure and the second seesaw structure are unified with potentials at the first anchor point and the second anchor point, respectively, to form differential drive. By a detection method in which two nested seesaw structures are driven by two carrier differential drives, when the base tilts around rotation axes where the first elastic members and the second elastic members are located under stress or other external factors, caused common mode changes of the differential detection assembly are canceled out, which can effectively suppress the impact of noise of an angular acceleration of rotation.

### BRIEF DESCRIPTION OF THE DRAWINGS

FIG. 1 is a schematic three-dimensional diagram of anchor points and seesaw structures provided according to an embodiment of the present invention;

FIG. 2 is a schematic planar diagram of anchor points and seesaw structures provided according to an embodiment of the present invention;

FIG. 3 is a modality of a first seesaw structure in an X-axis acceleration detection modality provided according to an embodiment of the present invention;

FIG. 4 is a modality of a second seesaw structure in an X-axis acceleration detection modality provided according to an embodiment of the present invention;

FIG. 5 is a modality of a first seesaw structure in a Y-axis acceleration detection modality provided according to an embodiment of the present invention;

FIG. 6 is a modality of a second seesaw structure in a Y-axis acceleration detection modality provided according to an embodiment of the present invention;

FIG. 7 is a modality of a first seesaw structure in a Z-axis acceleration detection modality provided according to an embodiment of the present invention; and

FIG. 8 is a modality of a second seesaw structure in a Z-axis acceleration detection modality provided according to an embodiment of the present invention.

### DETAILED DESCRIPTION OF THE EMBODIMENTS

The present invention is further described below in combination with accompanying drawings and implementations.

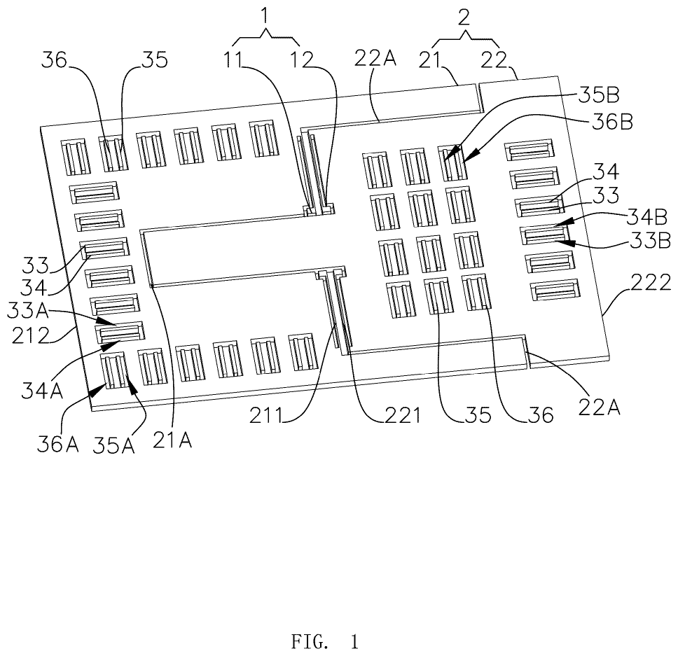

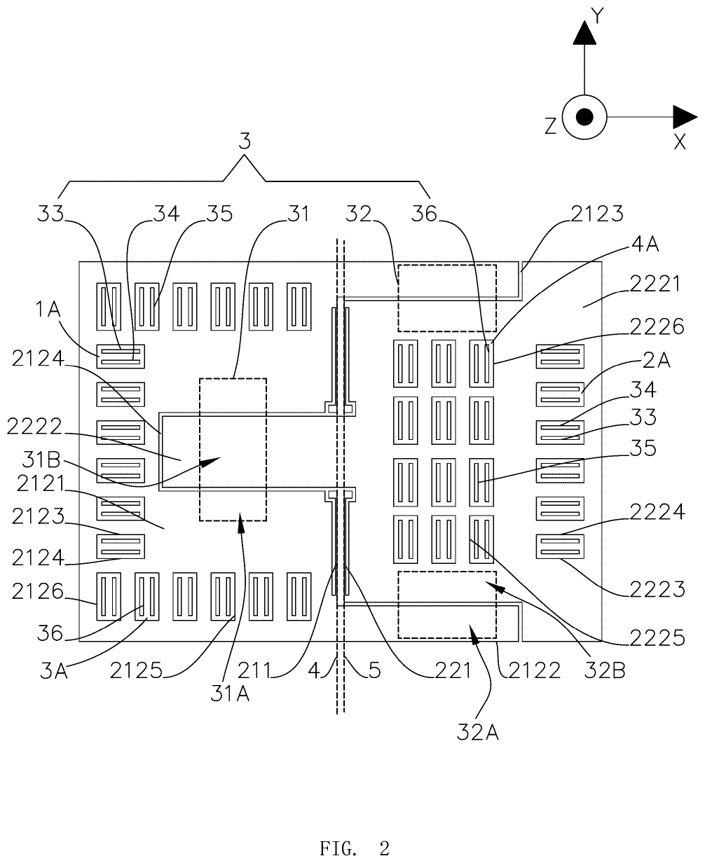

Referring to FIG. 1 and FIG. 2, an embodiment of the present invention provides an accelerometer, which includes a base, anchor points 1 arranged on the base, and the seesaw structures 2 are elastically connected to the anchor points 1 and supported on the base via the anchor points 1, the seesaw structures 2 are spaced apart from the base. The accelerometer further includes a differential detection assembly 3 for detecting an acceleration of the seesaw structures 2. The seesaw structures 2 include a first seesaw structure 21 and a second seesaw structure 22 which are parallel to each other and placed in reverse. The anchor points 1 include first anchor points 11 elastically connected to the first seesaw structure 21, and second anchor points 12 elastically connected to the second seesaw structure 22. The first seesaw structure 21 includes first elastic members 211 connected to the first anchor points 11, and a first mass block 212 connected to the first elastic members 211. The first mass block 212 is driven by a normal phase carrier drive signal from the first anchor points 11. The second seesaw structure 22 includes second elastic members 221 connected to the corresponding second anchor points 12, and a second mass block 222 connected to the second elastic members 221. The second mass block 222 is driven by a reversed phase carrier drive signal from the second anchor points 12.

The first mass block 212 and the second mass block 222 are asymmetric structures. The first mass block 212 comprises a first mass portion 2121 connected to the first elastic members 211, and two second mass portions 2122 extending from the first mass portion 2121 in a X-axis direction toward the second mass block 222; the two second mass portions 2122 are spaced apart in a Y-axis direction; the X-axis direction is perpendicular to the Y-axis direction; the second mass block 222 comprises a third mass portion 2221 connected to the second elastic members 221, and a fourth mass portion 2222 extending from the third mass portion 2221 in the X-axis direction toward the first mass block 212; the side of the first mass portion 2121 facing the second mass block 222 in the X-axis direction is recessed away from the second mass block 222 along the X-axis direction to form a first recess 21A; the fourth mass portion 2222 is received in the first recess 21A; the two second mass portions 2122 are arranged on opposite sides of the third mass portion 2221 in the Y-axis direction.

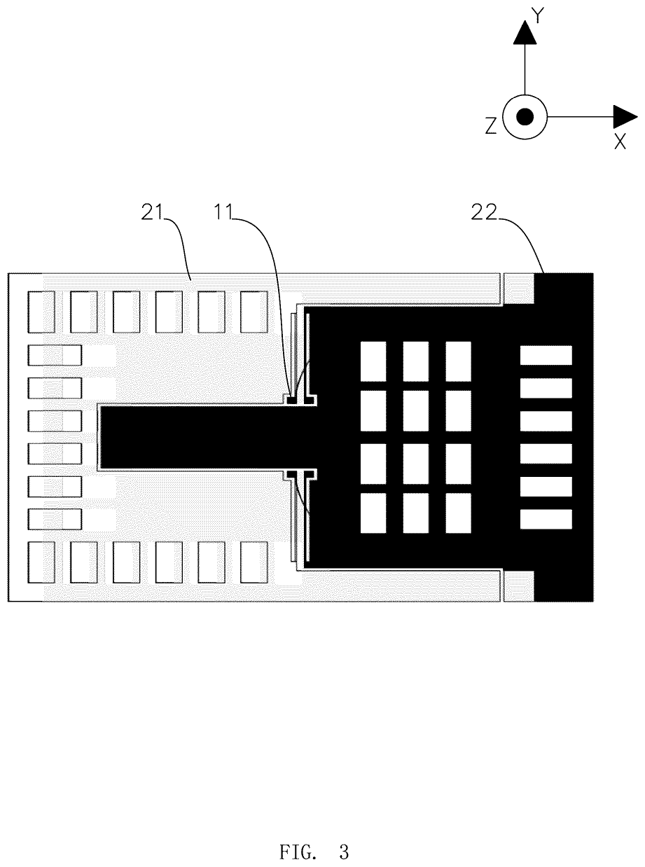

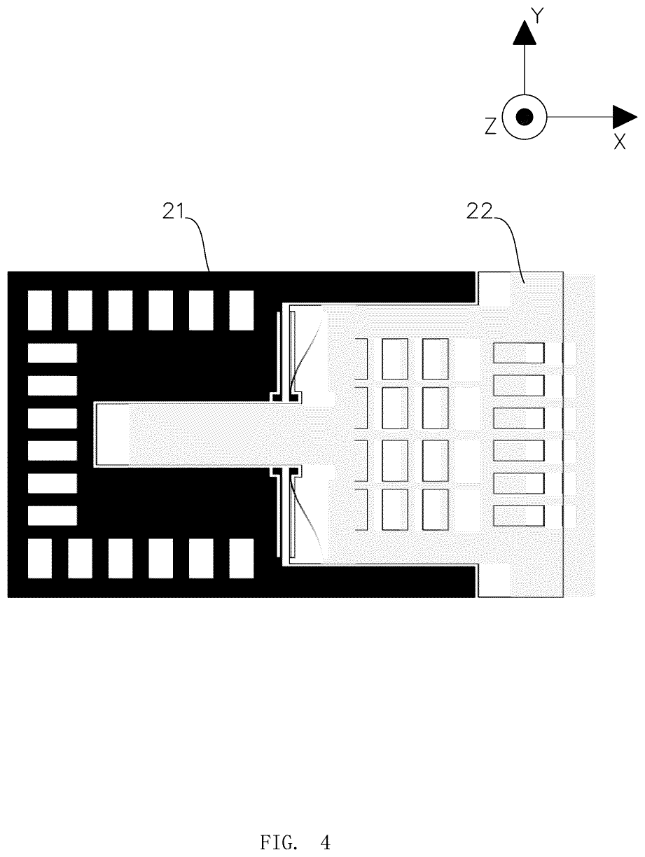

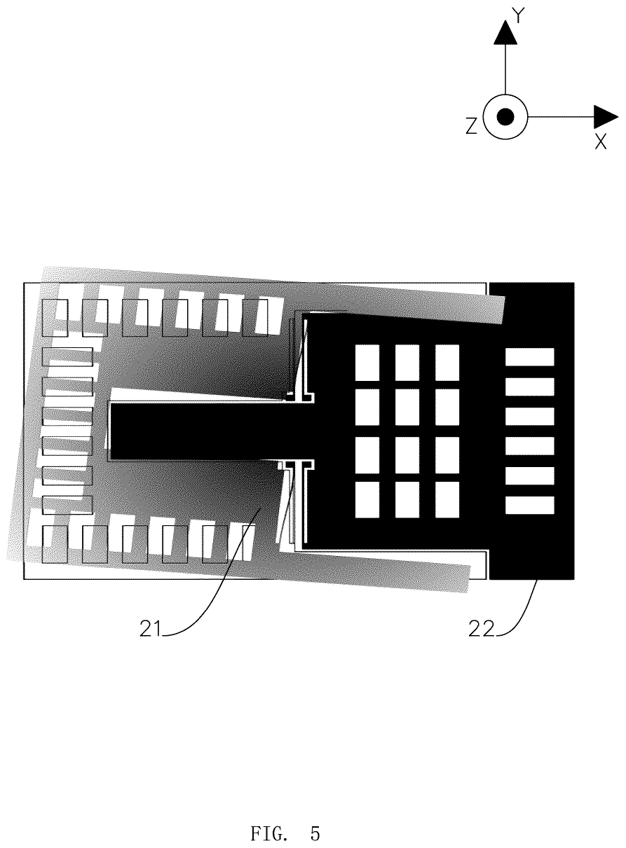

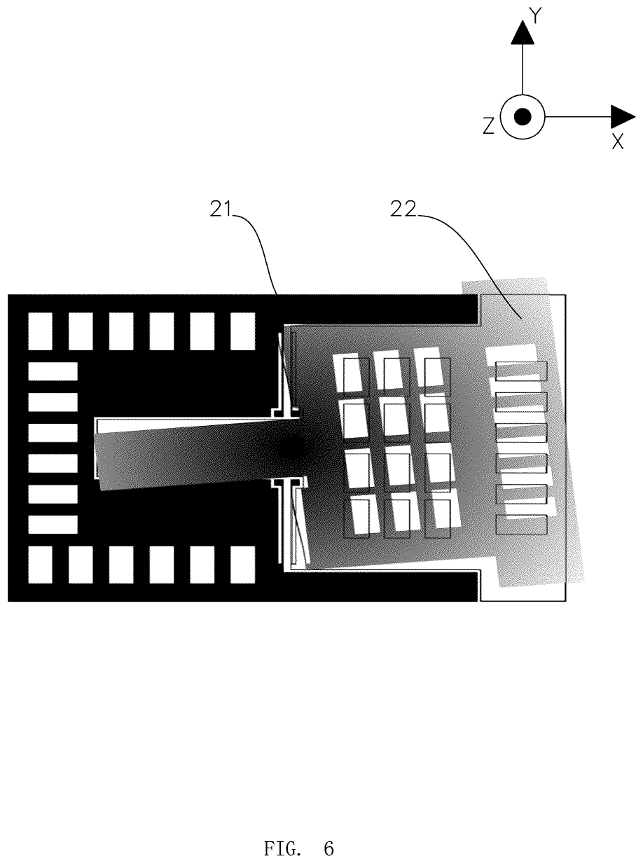

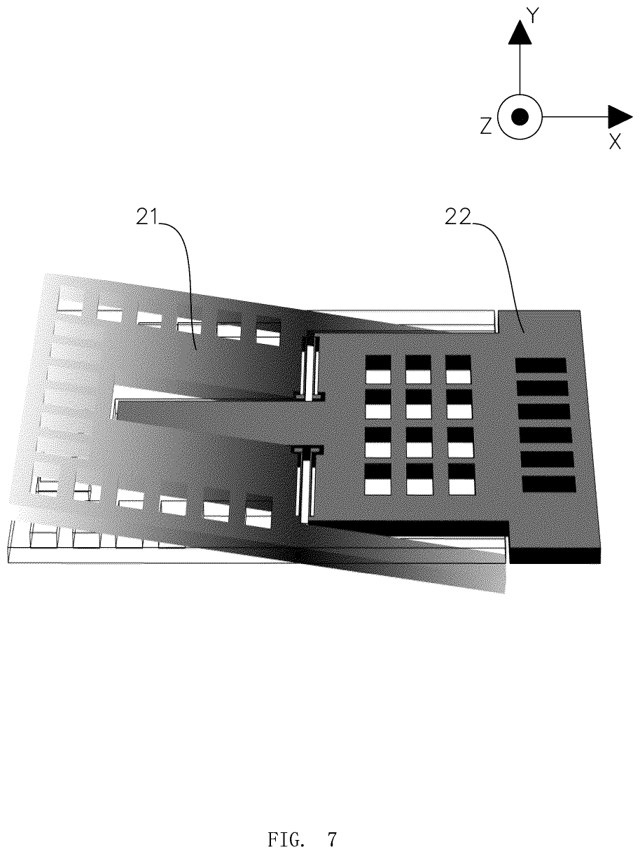

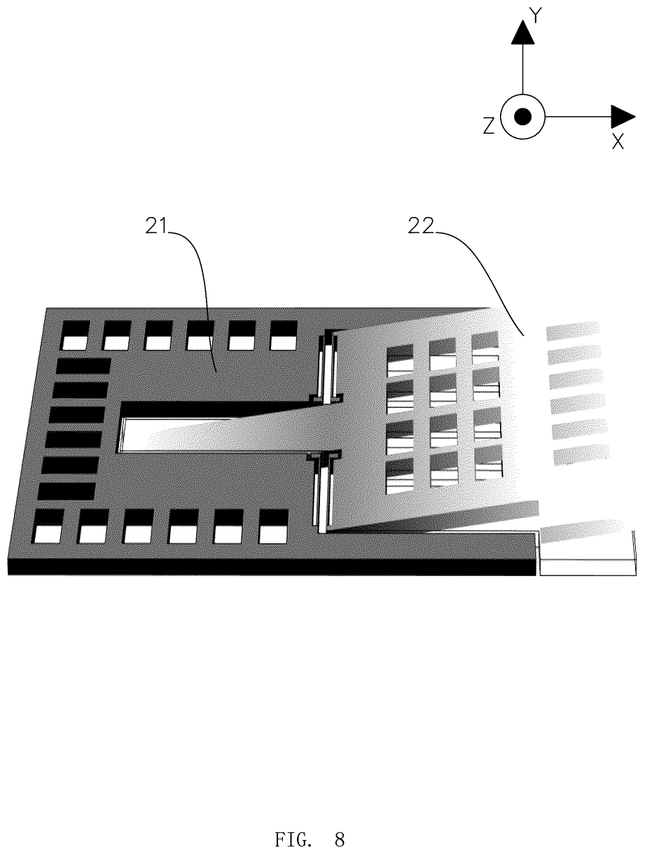

A plane where the base is located is a base plane. The anchor points 1 are fixed on the base plane. FIG. 7 and FIG. 8 show Z-axis acceleration detection modalities. Under the action of an acceleration in a Z-axis direction, the first seesaw structure 21 rotates and tilts anticlockwise around a first rotation axis 4 (i.e. an axial line formed by the first elastic members 211 and the first anchor points 11), and the second seesaw structure 22 rotates and tilts clockwise around a second rotation axis 5 (i.e. an axial line formed by the second elastic members 221 and the second anchor points 12); and the first rotation axis 4 and the second rotation axis 5 are in the same direction as the Y axis direction. FIG. 5 and FIG. 6 show Y-axis acceleration detection modalities. Under the action of an acceleration in a Y-axis direction, the first seesaw structure 21 rotates and tilts clockwise around the Z axis direction, and the second seesaw structure 22 rotates and tilts anticlockwise around the Z axis direction. FIG. 3 and FIG. 4 show X-axis acceleration detection modalities. Under an acceleration in an X-axis direction, the first seesaw structure 21 and the second seesaw structure 22 both translate along the X axis direction. By means of adjusting parameters of the first elastic members 211 and the second elastic members 221, corresponding modality frequencies of the various axes between the first seesaw structure 21 and the second seesaw structure 22 are close or even consistent. The first seesaw structure 21 and the second seesaw structure 22 are independent of each other. The normal phase carrier drive signal and the reversed phase carrier drive signal with opposite phases are respectively applied to the first anchor points 11 and the second anchor points 12 of the parallel and reversed first seesaw structure 21 and second seesaw structure 22. Potentials of the first seesaw structure 21 and the second seesaw structure 22 are unified with potentials at the first anchor points 11 and the second anchor points 12, respectively, to form differential drive. By a detection method in which two parallel and reversed seesaw structures 2 are driven by two carrier differential drives, when the base tilts around rotation axes where the first elastic members 211 and the second elastic members 221 are located under stress or other external factors, caused common mode changes of the differential detection assembly 3 are canceled out, which can effectively suppress the impact of noise of an angular acceleration of rotation.

The first mass portion 2121 and the second mass portion 2122 are asymmetric structures by taking the first rotation axis 4 as an axial line. The third mass portion 2221 and the fourth mass portion 2222 are asymmetric structures by taking the second rotation axis 5 as an axial line. Of course, the first mass block 212 and the second mass block 222 can also be asymmetric structures by taking the first rotation axis 4 or the second rotation axis 5 as an axial line. The moment of inertia of the first mass portion 2121 around the first elastic member 211 matches the moment of inertia of the fourth mass portion 2222 around the second elastic member 221. The moment of inertia of the second mass portion 2122 around the first elastic member 211 matches the moment of inertia of the third mass portion 2221 around the second elastic member 221.

The two sides of the third mass portion 2221 in the Y-axis direction are recessed towards each other along the Y-axis direction to form two second recesses 22A, and the two second mass portions 2122 are correspondingly accommodated in the two second recesses 22A; the first anchor points 11 are disposed between the first mass portion 2121 and the third mass portion 2221 and are connected to the first mass portion 2121 via the first elastic members 211; the second anchor points 12 are disposed between the first mass portion 2121 and the third mass portion 2221 and are connected to the third mass portion 2221 via the second elastic members 221.

The first anchor points 11 include two and are spaced apart along the Y-axis direction on both sides of the fourth mass portion 2222; the first elastic members 211 include two, and each of the first anchor points 11 is connected to the first mass portion 2121 via one first elastic member 211; the second anchor points 12 include two and are spaced apart along the Y-axis direction on both sides of the fourth mass portion 2222; the second elastic members 221 include two, and each of the second anchor points 12 is connected to the third mass portion 2221 via one second elastic member 221. The mass distribution of the first mass block 212 on both sides of the first elastic members 211 is asymmetric. An inertial test mass block is an asymmetric portion of the mass distribution of the first mass block 212 (i.e. an asymmetric portion taking the first rotation axis 4 as the axial line). One side of the first elastic members 211 where the first mass block 212 is located is the first mass portion 2121, and the other side of the first elastic members 211 is the second mass portion 2122. The mass distribution of the second mass block 222 on both sides of the second elastic members 221 is asymmetric. An inertial test mass block is an asymmetric portion of the mass distribution of the second mass block 222 (i.e. an asymmetric portion taking the second rotation axis 5 as the axial line). One side of the second elastic members 221 where the second mass block 222 is located is the third mass portion 2221, and the other side of the second elastic members 221 is the fourth mass portion 2222.

The first seesaw structure 21 and the second seesaw structure 22 can also be nested to form a rectangular structure. At this time, the first recess 21A is recessed away from the second mass block 222 from the middle of the side of the first mass portion 2121 facing the second mass block 222.

The differential detection assembly 3 includes a first Z-axis capacitance detection electrode 31 arranged on the base, and the orthographic projection of the first Z-axis capacitance detection electrode 31 along the Z-axis direction covers a portion of the first mass portion 2121 and a portion of the fourth mass portion 2222; a first Z-axis differential detection capacitor 31A is formed by the spacing between the portion of the first Z-axis capacitance detection electrode 31 facing the first mass portion 2121 in the Z-axis direction and the first mass portion 2121; a second Z-axis differential detection capacitor 31B is formed by the spacing between the portion of the first Z-axis capacitance detection electrode 31 facing the fourth mass portion 2222 in the Z-axis direction and the fourth mass portion 2222; and plate spacings of the first Z-axis differential detection capacitor 31A and the second Z-axis differential detection capacitor 31B are the same

In this embodiment, the first Z-axis differential detection capacitor 31A and the second Z-axis differential detection capacitor 31B in this embodiment have approximately the same overlapping areas and approximately the same plate spacings. The overlapping areas may be equal or unequal. A Z-axis out-of-plane acceleration acts on the seesaw structures 2, so that the first seesaw structure 21 rotates and tilts around a rotation axis where the first elastic members 211 are located, and the second seesaw structure 22 rotates and tilts around the second elastic members 221 in an opposite direction, and a differential change occurs in a capacitor spacing between the first Z-axis differential detection capacitor 31A and the second Z-axis differential detection capacitor 31B. Differential mode changes of the first Z-axis differential detection capacitor 31A and the second Z-axis differential detection capacitor 31B caused by the tilting of the first seesaw structure 21 and the second seesaw structure 22 can be detected by means of a capacitance detection circuit connected to the first Z-axis capacitance detection electrode 31, thus calculating the Z-axis acceleration.

When the first seesaw structure 21 and the second seesaw structure 22 are affected by noise of external angular accelerations of rotations around the first elastic members 211 and the second elastic members 221 respectively, and when the first seesaw structure 21 and the second seesaw structure 22 rotate and tilt in the same direction around the rotation axes where the first elastic members 211 and the second elastic members 221 are located respectively, caused common mode changes of the differential detection of the first Z-axis differential detection capacitor 31A and the second Z-axis differential detection capacitor 31B are canceled out, so that the impact of the noise of the external angular accelerations of the rotations around the first elastic members 211 and the second elastic members 221 is reduced.

When the base tilts around the rotation axes where the first elastic members 211 and the second elastic members 221 are located under stress or other external factors, the caused common mode changes of the first Z-axis differential detection capacitor 31A and the second Z-axis differential detection capacitor 31B are canceled out, so that the impact of the noise of the external angular accelerations of the rotations around the first elastic members 211 and the second elastic members 221 is reduced.

The differential detection assembly 3 further includes a second Z-axis capacitance detection electrode 32 arranged on the base. The orthographic projection of each second Z-axis capacitance detection electrode 32 along the Z-axis direction covers a portion of the second mass portion 2122 and a portion of the third mass portion 2221; a third Z-axis differential detection capacitor 32A is formed by the spacing between the portion of the second Z-axis capacitance detection electrode 32 facing the second mass portion 2122 in the Z-axis direction and the second mass portion 2122; a fourth Z-axis differential detection capacitor 32B is formed by the spacing between the portion of the second Z-axis capacitance detection electrode 32 facing the third mass portion 2221 in the Z-axis direction and the third mass portion 2221; plate spacing of the third Z-axis differential detection capacitor 32A and the fourth Z-axis differential detection capacitor 32B are the same, and plate spacing of the third Z-axis differential detection capacitor 32A is the same as that of the first Z-axis differential detection capacitor 31A, so as to form two sets of differential Z-axis detection capacitors. A product of an area of a plate of the third Z-axis differential detection capacitor 32A and a distance between the plate and the first elastic members 211 is equal to a product of an area of a plate of the fourth Z-axis differential detection capacitor 32B and a distance between the plate and the second elastic members 221. A product of the area of the plate of the third Z-axis differential detection capacitor 32A and the distance between the plate and the first elastic members 211 is equal to a product of the area of the plate of the first Z-axis differential detection capacitor 31A and the distance between the plate and the first elastic members 211.

The third Z-axis differential detection capacitor 32A and the fourth Z-axis differential detection capacitor 32B have an overlapping area approximately equal to that of the first Z-axis differential detection capacitor 31A and the second Z-axis differential detection capacitor 32B, and the plate spacings of the third Z-axis differential detection capacitor 32A and the fourth Z-axis differential detection capacitor 32B are approximately the same as the plate spacings of the first Z-axis differential detection capacitor 31A and the second Z-axis differential detection capacitor 31B, thus forming a dual-differential detection capacitor. By means of the differential detection, the anti-interference capacity and acceleration detection sensitivity of the accelerometer can be further improved. It should be noted that a product of an area of a plate of the fourth Z-axis differential detection capacitor 32B and a distance between the plate and the second elastic members 221 is equal to a product of an area of a plate of the second Z-axis differential detection capacitor 31B and a distance between the plate and the second elastic members 221, and plate spacings of the fourth Z-axis differential detection capacitor 32B and the second Z-axis differential detection capacitor 31B are the same.

The first mass block 212 includes a plurality of first through holes 1A extending along the Z-axis direction through the first mass block 212, the plurality of first through holes 1A being arranged along the Y-axis and spaced apart from each other, each first through hole 1A being rectangular with a long side parallel to the X-axis direction; the second mass block 222 includes a plurality of second through holes 2A extending along the Z-axis direction through the second mass block 222, the plurality of second through holes 2A being arranged along the Y-axis and spaced apart from each other, each second through hole 2A being rectangular with a long side parallel to the X-axis direction; each first through hole 1A has a first side wall 2123 parallel to the X-axis direction; each second through hole 2A has a second side wall 2223 parallel to the X-axis direction; the differential detection assembly 3 includes a plurality of first Y-axis differential detection capacitor 33 disposed on the base and located within the plurality of first through holes and the plurality of second through holes, the plurality of first Y-axis capacitance detection electrodes 33 being correspondingly arranged with the plurality of first through holes 1A and the plurality of second through holes 2A; a first Y-axis differential detection capacitor 33A is formed between each first Y-axis capacitive detection electrode 33 and the first side wall facing the first Y-axis capacitance detection electrode 33, and a second Y-axis differential detection capacitor 33B is formed between each first Y-axis capacitance detection electrode 33 and the second side wall facing the first Y-axis capacitance detection electrode 33. Plate spacings of the first Y-axis differential detection capacitor 33A and the second Y-axis differential detection capacitor 33B are the same.

The base is provided with the first Y-axis capacitance detection electrode 33 perpendicular to the base plane, and the first Y-axis capacitance detection electrode 33 is perpendicular to the Y axis direction. The first Y-axis differential detection capacitor 33A and the second Y-axis differential detection capacitor 33B have approximately the same overlapping areas and approximately the same plate spacings. A Y-axis acceleration acts on the seesaw structures 2, so that the first seesaw structure 21 and the second seesaw structure 22 rotates and tilts in opposite directions, and a differential change occurs in a capacitor spacing between the first Y-axis differential detection capacitor 33A and the second Y-axis differential detection capacitor 33B. Differential mode changes of the first Z-axis differential detection capacitor 33A and the second Z-axis differential detection capacitor 33B caused by the tilting of the seesaws can be detected by means of a capacitance detection circuit connected to the first Y-axis capacitance detection electrode 33, thus calculating the Y-axis acceleration.

When the first seesaw structure 21 and the second seesaw structure 22 are affected by noise of external angular accelerations of rotations around the Z axis direction, and when the first seesaw structure 21 and the second seesaw structure 22 rotate and tilt in the same direction around the Z-axis direction, caused common mode changes of the differential detection capacitors are canceled out, so that the impact of the noise of the external angular accelerations of the rotations around a central rotation axis is reduced.

The first through holes 1A each further include a third side wall 2124 opposite to the first side wall 2123 along the Y-axis direction, and the second through holes 2A each further include a fourth side wall 2224 opposite to the second side wall 2223 along the Y-axis direction, and the differential detection assembly 3 further includes a plurality of second Y-axis capacitance detection electrodes 34 disposed on the base and located within the plurality of first through holes 1A and the plurality of second through holes 2A, a third Y-axis differential detection capacitor 34A is formed between each second Y-axis capacitance detection electrode 34 and the third side wall 2124 facing the second Y-axis capacitance detection electrode 34, and a fourth Y-axis differential detection capacitor 34B is formed between each second Y-axis capacitance detection electrode 34 and the fourth side wall 2224 facing the second Y-axis capacitance detection electrode 34. Plate spacings of the third Y-axis differential detection capacitor 34A and the fourth Y-axis differential detection capacitor 34B are the same. The third Y-axis differential detection capacitor 34A and the first Y-axis differential detection capacitor 34B have the same overlapping areas and the same plate spacings, and the fourth Y-axis differential detection capacitor 34B and the second Y-axis differential detection capacitor 33B have the same overlapping areas and the same plate spacings, so as to form two sets of Y-axis detection capacitor.

The third Y-axis differential detection capacitor 34A and the fourth Y-axis differential detection capacitor 34B have an overlapping area approximately equal to that of the first Y-axis differential detection capacitor 33A and the second Y-axis differential detection capacitor 33B, and the plate spacings of the third Y-axis differential detection capacitor 34A and the fourth Y-axis differential detection capacitor 34B are approximately the same as the plate spacings of the first Y-axis differential detection capacitor 33A and the second Y-axis differential detection capacitor 33B, thus forming a dual-differential detection capacitor. By means of the differential detection, the anti-interference capacity and acceleration detection sensitivity of the accelerometer can be further improved.

The first mass block 212 further includes a plurality of third through holes 3A extending along the Z-axis direction through the first mass block 212, the plurality of third through holes 3A being arranged along the X-axis and spaced apart from each other, each third through hole 3A being rectangular with a long side parallel to the Y-axis direction, the second mass block 222 further includes a plurality of fourth through holes 4A extending along the Z-axis direction through the second mass block 222, the plurality of fourth through holes 4A being arranged along the Y-axis and spaced apart from each other, each fourth through hole 4A being rectangular with a long side parallel to the Y-axis direction, each third through hole 3A further includes a fifth side wall 2125 parallel to the Y-axis direction, each fourth through hole 4A further includes a sixth side wall 2225 parallel to the Y-axis direction, and the differential detection assembly 3 further includes a plurality of first X-axis capacitance detection electrodes 35 disposed on the base and located within the plurality of third through holes 3A and the plurality of fourth through holes 4A, a first X-axis differential detection capacitor 35A is formed between each first X-axis capacitance detection electrode 35 and the fifth side wall 2125 facing the first X-axis capacitance detection electrode 35, and a second X-axis differential detection capacitor 35B is formed between each first X-axis capacitance detection electrode 35 and the sixth side wall 2225 facing the first X-axis capacitance detection electrode 35. Plate spacings of the first X-axis differential detection capacitor 35A and the second X-axis differential detection capacitor 35B are the same.

The base is provided with the first X-axis capacitance detection electrode 35 perpendicular to the base plane, and the first X-axis capacitance detection electrode 35 is perpendicular to the X axis. The first X-axis differential detection capacitor 35A and the second X-axis differential detection capacitor 35B have approximately the same overlapping areas and approximately the same plate spacings. An X-axis acceleration acts on the seesaw structures 2, so that the first seesaw structure 21 and the second seesaw structure 22 translate around the Z axis along the X axis, and a differential change occurs in a capacitor spacing between the first X-axis differential detection capacitor 35A and the second X-axis differential detection capacitor 35B. Differential mode changes of the first X-axis differential detection capacitor 35A and the second X-axis differential detection capacitor 35B caused by the tilting of the seesaws can be detected by means of a capacitance detection circuit connected to the first X-axis capacitance detection electrode 35, thus calculating the X-axis acceleration.

The third through holes 3A each further include a seventh side wall 2126 opposite to the fifth side wall 2125 along the X-axis direction, and the fourth through holes 4A each further include an eighth side wall 2226 opposite to the sixth side wall 2225 along the X-axis direction, and the differential detection assembly 3 further includes a plurality of second X-axis capacitance detection electrodes 36 disposed on the base and located within the plurality of third through holes 3A and the plurality of fourth through holes 4A, a third X-axis differential detection capacitor 36A is formed between each second X-axis capacitance detection electrode 36 and the seventh side wall 2126 facing the second X-axis capacitance detection electrode 36, and a fourth X-axis differential detection capacitor 36B is formed between each second X-axis capacitance detection electrode 36 and the eighth side wall 2226 facing the second X-axis capacitance detection electrode 36. Plate spacings of the third X-axis differential detection capacitor 36A and the fourth X-axis differential detection capacitor 36B are the same. The third X-axis differential detection capacitor 36A and the first X-axis differential detection capacitor 35A have the same overlapping areas and the same plate spacings, and the fourth X-axis differential detection capacitor 36B and the second X-axis differential detection capacitor 35B have the same overlapping areas and the same plate spacings, so as to form a dual-differential X-axis detection capacitor.

The third X-axis differential detection capacitor 36A and the fourth X-axis differential detection capacitor 36B have an overlapping area approximately equal to that of the first X-axis differential detection capacitor 35A and the second X-axis differential detection capacitor 35B, and the plate spacings of the third X-axis differential detection capacitor 36A and the fourth X-axis differential detection capacitor 36B are approximately the same as the plate spacings of the first X-axis differential detection capacitor 35A and the second X-axis differential detection capacitor 35B, thus forming two sets of X-axis detection capacitors. By means of the differential detection, the anti-interference capacity and acceleration detection sensitivity of the accelerometer can be further improved.

The plurality of third through holes 3A includes at least two columns arranged at intervals along the Y-axis direction; the plurality of fourth through holes 4A includes at least two columns arranged at intervals along the X-axis direction.

It should be noted that the acceleration of each axis can be detected by connecting a single detection electrode to a capacitance detection circuit, so that differential electrode arrangement is adopted to further improve the robustness and detection sensitivity of the accelerometer.

The first elastic member 211 is arranged on the corresponding first anchor points 11 and connected with the first mass block 212 to achieve motion of the first seesaw. Of course, the two second anchor points 12 are oppositely arranged on both sides of the fourth mass portion 2222, and are respectively fixed on the base. Furthermore, the second anchor points 12 and the first anchor points 11 on the same side are spaced apart. Correspondingly, the second elastic members 221 are arranged on the corresponding second anchor point 12 and connected with the third mass portion 2221 to achieve motion of the second seesaw. It should be noted that the number of the first anchor points 11 and the number of the second anchor points 12 can also be a single or multiple, and there is no special restriction on this here, as long as the first seesaw structure 21 can be flexibly fixed to the first anchor points 11 through the first elastic members 211, and the second seesaw structure 22 can be flexibly fixed to the second anchor points 12 through the second elastic members 221. Of course, the number of the first elastic members 211 and the number of the second elastic members 221 can also be set correspondingly. In this embodiment, the first elastic members 211 and the second elastic members 221 are preferably springs. Of course, in some other embodiments, the first elastic members 211 and the second elastic members 221 can also be other types of elastic members.

The accelerometer further includes an upper cover arranged on one side of the seesaw structures 2 facing away from the base.

A plane where the upper cover is located is an upper cover plane, and the upper cover plane and the base plane are respectively located above and below a plane where the seesaw structures 2 are located. The first Z-axis capacitance detection electrode 31, the second Z-axis capacitance detection electrode 32, the second Y-axis capacitance detection electrode 34 and/or the second X-axis capacitance detection electrode 36 can also be arranged on the upper cover plane.

The implementation modes of the present invention are described above only. It should be noted that those of ordinary skill in the art can further make improvements without departing from the concept of the present invention. These improvements shall all fall within the protection scope of the present invention.

What is claimed is:

1. An accelerometer, comprising base, anchor points arranged on the base, and seesaw structures elastically connected to the anchor points, wherein the accelerometer further comprises a differential detection assembly used for detecting accelerations of the seesaw structures; the seesaw structures comprise a first seesaw structure and a second seesaw structure, wherein the first seesaw structure and second seesaw structure are nested; the anchor points comprise first anchor points elastically connected to the first seesaw structure, and second anchor points elastically connected to the second seesaw structure;
the first seesaw structure comprises first elastic members connected to the first anchor points, and a first mass block connected to the first elastic members; the first mass block is driven by a normal phase carrier drive signal from the first anchor points;
the second seesaw structure comprises second elastic members connected to the second anchor points, and a second mass block connected to the second elastic members; and the second mass block is driven by a reversed phase carrier drive signal from the second anchor points;
the first mass block comprises a first mass portion connected to the first elastic members, and two second mass portions extending from the first mass portion in a X-axis direction toward the second mass block; the two second mass portions are spaced apart in a Y-axis direction; the X-axis direction is perpendicular to the Y-axis direction;
the second mass block comprises a third mass portion connected to the second elastic members, and a fourth mass portion extending from the third mass portion in the X-axis direction toward the first mass block;
the side of the first mass portion facing the second mass block in the X-axis direction is recessed away from the second mass block along the X-axis direction to form a first recess; the fourth mass portion is received in the first recess; the two second mass portions are arranged on opposite sides of the third mass portion in the Y-axis direction;
under the action of an acceleration in a Z-axis direction, the first seesaw structure rotates and tilts anticlockwise around the Y-axis direction, and the second seesaw structure rotates and tilts clockwise around the Y-axis direction; under the action of an acceleration in the Y-axis direction, the first seesaw structure rotates and tilts clockwise around the Z axis direction, and the second seesaw structure rotates and tilts anticlockwise around the Z axis direction; under an acceleration in the X-axis direction, the first seesaw structure and the second seesaw structure both translate along the X axis direction; the Z-axis direction is perpendicular to the X-axis direction and the Y-axis direction.

2. The accelerometer according to claim 1, wherein the two sides of the third mass portion in the Y-axis direction are recessed towards each other along the Y-axis direction to form two second recesses, and the two second mass portions are correspondingly accommodated in the two second recesses; the first anchor points are disposed between the first mass portion and the third mass portion and are connected to the first mass portion via the first elastic members; the second anchor points are disposed between the first mass portion and the third mass portion and are connected to the third mass portion via the second elastic members.

3. The accelerometer according to claim 2, wherein the first seesaw structure and the second seesaw structure are nested to form a rectangular structure.

4. The accelerometer according to claim 2, wherein the first anchor points include two and are spaced apart along the Y-axis direction on both sides of the fourth mass portion; the first elastic members include two, and each of the first anchor points is connected to the first mass portion via one first elastic member; the second anchor points include two and are spaced apart along the Y-axis direction on both sides of the fourth mass portion; the second elastic members include two, and each of the second anchor points is connected to the third mass portion via one second elastic member.

5. The accelerometer according to claim 1, wherein the moment of inertia of the first mass portion around the first elastic members matches the moment of inertia of the fourth mass portion around the second elastic members; and the moment of inertia of the two second mass portions around the first elastic members matches the moment of inertia of the third mass portion around the second elastic members.

6. The accelerometer according to claim 1, wherein the differential detection assembly includes a first Z-axis capacitance detection electrode disposed on the base, and the orthographic projection of the first Z-axis capacitance detection electrode along the Z-axis direction covers a portion of the first mass portion and a portion of the fourth mass portion; a first Z-axis differential detection capacitor is formed by the spacing between the portion of the first Z-axis capacitance detection electrode facing the first mass portion in the Z-axis direction and the first mass portion; a second Z-axis differential detection capacitor is formed by the spacing between the portion of the first Z-axis capacitance detection electrode facing the fourth mass portion in the Z-axis direction and the fourth mass portion; and plate spacings of the first Z-axis differential detection capacitor and the second Z-axis differential detection capacitor are the same.

7. The accelerometer according to claim 6, wherein the differential detection assembly further comprises two second Z-axis capacitance detection electrodes disposed on the base, the orthographic projection of each second Z-axis capacitance detection electrode along the Z-axis direction covers a portion of the second mass portion and a portion of the third mass portion; a third Z-axis differential detection capacitor is formed by the spacing between the portion of the second Z-axis capacitance detection electrode facing the second mass portion in the Z-axis direction and the second mass portion; a fourth Z-axis differential detection capacitor is formed by the spacing between the portion of the second Z-axis capacitance detection electrode facing the third mass portion in the Z-axis direction and the third mass portion; plate spacing of the third Z-axis differential detection capacitor and the fourth Z-axis differential detection capacitor are the same, and plate spacing of the third Z-axis differential detection capacitor is the same as that of the first Z-axis differential detection capacitor, so as to form two sets of differential Z-axis detection capacitors.

8. The accelerometer according to claim 1, wherein the first mass block includes a plurality of first through holes extending along the Z-axis direction through the first mass block, the plurality of first through holes being arranged along the Y-axis and spaced apart from each other, each first through hole being rectangular with a long side parallel to the X-axis direction; the second mass block includes a plurality of second through holes extending along the Z-axis direction through the second mass block, the plurality of second through holes being arranged along the Y-axis and spaced apart from each other, each second through hole being rectangular with a long side parallel to the X-axis direction; each first through hole has a first side wall parallel to the X-axis direction; each second through hole has a second side wall parallel to the X-axis direction; the differential detection assembly includes a plurality of first Y-axis capacitance detection electrodes disposed on the base and located within the plurality of first through holes and the plurality of second through holes, the plurality of first Y-axis capacitance detection electrodes being correspondingly arranged with the plurality of first through holes and the plurality of second through holes; a first Y-axis differential detection capacitor is formed between each Y-axis capacitive detection electrode and the first side wall facing the first Y-axis capacitance detection electrode, and a second Y-axis differential detection capacitor is formed between each first Y-axis capacitance detection electrode and the second side wall facing the first Y-axis capacitance detection electrode;
plate spacings of the first Y-axis differential detection capacitor and the second Y-axis differential detection capacitor are the same.

9. The accelerometer according to claim 8, wherein the first through holes each further include a third side wall opposite to the first side wall along the Y-axis direction, and the second through holes each further include a fourth side wall opposite to the second side wall along the Y-axis direction, and the differential detection assembly further includes a plurality of second Y-axis capacitance detection electrodes disposed on the base and located within the plurality of first through holes and the plurality of second through holes, a third Y-axis differential detection capacitor is formed between each second Y-axis capacitance detection electrode and the third side wall facing the second Y-axis capacitance detection electrode, and a fourth Y-axis differential detection capacitor is formed between each second Y-axis capacitance detection electrode and the fourth side wall facing the second Y-axis capacitance detection electrode;
plate spacings of the third Y-axis differential detection capacitor and the fourth Y-axis differential detection capacitor are the same; and plate spacings of the third Y-axis differential detection capacitor and the first Y-axis differential detection capacitor are the same; so as to form two sets of Y-axis detection capacitors.

10. The accelerometer according to claim 9, wherein the first mass block further includes a plurality of third through holes extending along the Z-axis direction through the first mass block, the plurality of third through holes being arranged along the X-axis and spaced apart from each other, each third through hole being rectangular with a long side parallel to the Y-axis direction, the second mass block further includes a plurality of fourth through holes extending along the Z-axis direction through the second mass block, the plurality of fourth through holes being arranged along the Y-axis and spaced apart from each other, each fourth through hole being rectangular with a long side parallel to the Y-axis direction, each third through hole further includes a fifth side wall parallel to the Y-axis direction, each fourth through hole further includes a sixth side wall parallel to the Y-axis direction, and the differential detection assembly further includes a plurality of first X-axis capacitance detection electrodes disposed on the base and located within the plurality of third through holes and the plurality of fourth through holes, a first X-axis differential detection capacitor is formed between each first X-axis capacitance detection electrode and the fifth side wall facing the first X-axis capacitance detection electrode, and a second X-axis differential detection capacitor is formed between each first X-axis capacitance detection electrode and the sixth side wall facing the first X-axis capacitance detection electrode;
plate spacings of the first X-axis differential detection capacitor and the second X-axis differential detection capacitor are the same.

11. The accelerometer according to claim 10, wherein the third through holes each further include a seventh side wall opposite to the fifth side wall along the X-axis direction, and the fourth through holes each further include an eighth side wall opposite to the sixth side wall along the X-axis direction, and the differential detection assembly further includes a plurality of second X-axis capacitance detection electrodes disposed on the base and located within the plurality of third through holes and the plurality of fourth through holes, a third X-axis differential detection capacitor is formed between each second X-axis capacitance detection electrode and the seventh side wall facing the second X-axis capacitance detection electrode, and a fourth X-axis differential detection capacitor is formed between each second X-axis capacitance detection electrode and the eighth side wall facing the second X-axis capacitance detection electrode;
plate spacings of the third X-axis differential detection capacitor and the fourth X-axis differential detection capacitor are the same; plate spacings of the third X-axis differential detection capacitor and the first X-axis differential detection capacitor are the same; so as to form two sets of X-axis detection capacitors.

12. The accelerometer according to claim 10, wherein the plurality of third through holes includes at least two columns arranged at intervals along the Y-axis direction; the plurality of fourth through holes includes at least two columns arranged at intervals along the X-axis direction.

13. The accelerometer according to claim 1, wherein the accelerometer further comprising an upper cover arranged on one side of the seesaw structure facing away from the base.
